(19) United States
(12) Patent Application Publication
(10) Pub. No.: US 2010/0011442 A1
(43) Pub. Date: Jan. 14, 2010

(54) DATA SECURITY DEVICE FOR PREVENTING THE SPREADING OF MALWARE

(75) Inventor: Shi-Ming Zhao, Taipei City (TW)

Correspondence Address: GENE I. SU, 17F-1, No. 151, SEC. 4, XINYI ROAD, TAIPEI, TW

(73) Assignee: SumWinTek Corp., Hsinchu County (TW)

(21) Appl. No.: 12/267,625

(22) Filed: Nov. 10, 2008

Related U.S. Application Data
(60) Provisional application No. 61/079,139, filed on Jul. 9, 2008.

(51) Int. Cl. G06F 21/00

(52) U.S. Cl. 726/24

(57) ABSTRACT

A method and system for preventing spreading of malware, including: automatically launching an anti-malware control mechanism after a data security device connects to a computing device and receives power from the computing device, determining availability of a data path in the data security device before allowing data to pass through the data path, and scanning the data that passes through the data path.

### CROSS-REFERENCE TO RELATED APPLICATIONS

This application claims the benefit of the U.S. Provisional Application No. 61/079,139, filed on Jul. 9, 2008 and having Atty. Docket No. SWTK-0003-US-PRO. This related application is hereby incorporated by reference in its entirety.

### BACKGROUND OF THE INVENTION

1. Field of the Invention

Embodiments of the present invention relate generally to techniques for guarding against malware and more specifically to a data security device for preventing the spreading of malware.

2. Description of the Related Art

Unless otherwise indicated herein, the approaches described in this section are not prior art to the claims in this application and are not admitted to be prior art by inclusion in this section.

As more and more mobile devices become susceptible to security breaches, they are also becoming a convenient channel to spread malware. For example, a mobile device infected with one type of malware, a computer virus, can easily infect a computer after it is attached to it. Conversely, if the computer is already infected with another computer virus, then it can also quickly infect the mobile device after the two systems are coupled. In one conventional anti-virus solution, certain anti-virus software needs to be loaded onto at least the computer and also activated before the mobile device is attached to the computer. In another convention solution, at least the mobile device needs to be configured with certain anti-virus software to prevent the mobile device from becoming a carrier of unwanted malware. The aforementioned conventional approaches are costly, burdensome, and ineffective.

As the foregoing illustrates, what is needed is thus an improved mechanism to guard against the spreading of malware and address at least the problems discussed above.

### SUMMARY OF THE INVENTION

A method and system for preventing spreading of malware, including: automatically launching an anti-malware control mechanism after a data security device connects to a computing device and receives power from the computing device, determining availability of a data path in the data security device before allowing data to pass through the data path, and scanning the data that passes through the data path.

At least one advantage of the present invention is to provide a secure and safe environment for transmitting data from one device to another in the absence of an effective anti-malware prevention measure.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the drawings. It is to be noted, however, that the drawings illustrate only typical embodiments of this invention and are therefore not to be considered limiting of its scope, for the invention may admit to other equally effective embodiments.

FIG. 1 is a block diagram of a system 100 including a data security device 104 according to one embodiment of the present invention;

FIG. 2 is a flow chart illustrating a process 200 performed by the data security device 104 of FIG. 1, according to one embodiment of the present invention;

FIG. 3 is a flow chart illustrating a process 300 for allowing data transmission through a data path in a data security device 104, according to one embodiment of the present invention;

FIG. 4 is a flow chart illustrating a process 400 for updating the anti-malware control unit, according to one embodiment of the present invention;

FIG. 5A illustrates a simplified block diagram of a data security device 510 configured to establish the availability of a data path with a power control circuit, according to one embodiment of the present invention;

FIG. 5B illustrates a simplified block diagram of a data security device 550 configured to establish the availability of a data path with a power control circuit, according to another embodiment of the present invention; and

FIG. 5C illustrates a simplified block diagram of a data security device 570 configured to establish the availability of a data path with a connecting switch, according to one embodiment of the present invention.

### DETAILED DESCRIPTION

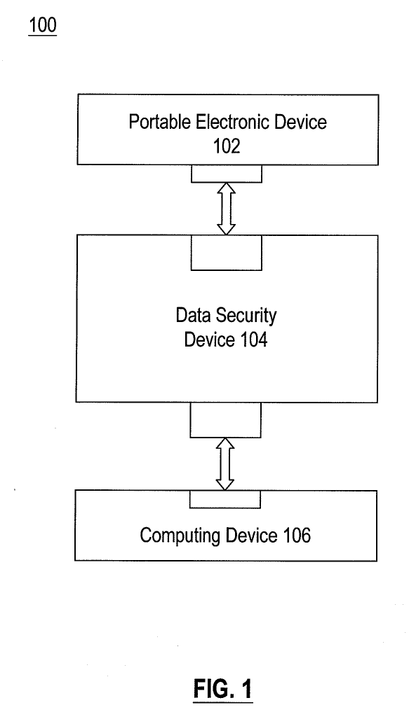

FIG. 1 is a block diagram of a system 100 including a data security device 104 according to one embodiment of the present invention. In one configuration, the system 100 includes a data security device 104, a computing device 106 coupled to one end of the data security device 104, and a portable electronic device 102 coupled to another end of the data security device 104. In one implementation, the connections adhere to the Universal Serial Bus (USB) standard. The data security device 104 is configured to prevent the spreading of malware between the two devices that are coupled to it. In one implementation, the data security device 104 includes an anti-malware control mechanism to scan, detect, and prevent any transmission of malware from one device to another. The portable electronic device 102 may be any device that has a memory unit for storing data. Some examples of the portable electronic device 102 include, without limitation, a mobile phone, a personal digital assistant, a portable hard drive, and a memory stick. The computing device 106 may be any device that has a memory unit for storing data and a processing unit for processing the data. Some examples of the computing device 106 include, without limitation, a desktop computer and a laptop computer. When the portable electronic device 102 transmits data to the computing device 106 through the data security device 104, the data travels through a data path in the data security device 104 and is scanned by a malware scanning engine. The malware scanning engine ensures that the data is free of malware and is not harmful to the computing device 106.

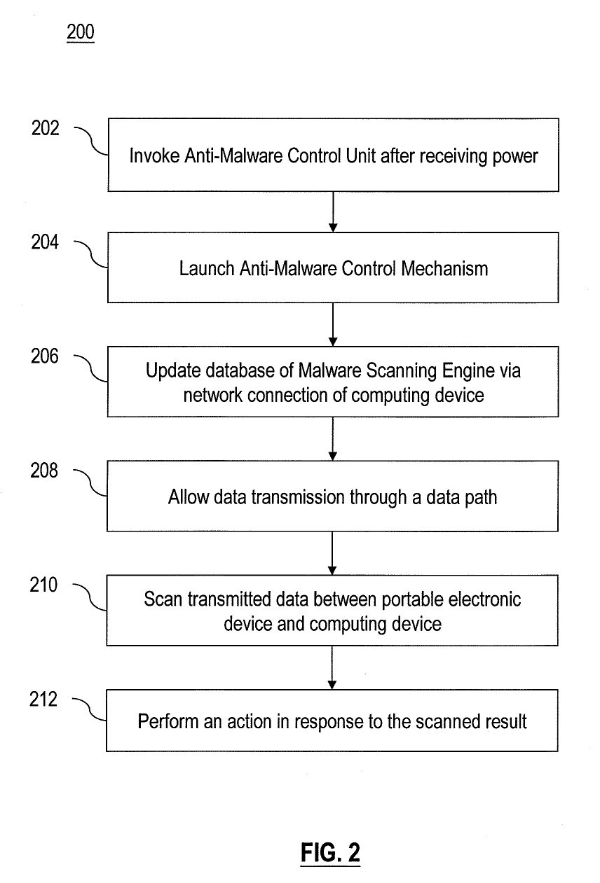

FIG. 2 is a flow chart illustrating a process 200 performed by the data security device 104 of FIG. 1, according to one embodiment of the present invention. Suppose the portable electronic device 102 and the computing device 106 shown in FIG. 1 is properly coupled to the data security device 104 via USB connections. In step 202, after power is supplied from the computing device 106 to the data security device 104, an anti-malware control unit of the data security device 104 is invoked. When the anti-malware control unit is invoked, an optional file in the root directory of the data security device 104 containing instructions to launch the anti-malware control mechanism is detected by the computing device 106. When the optional file is detected, the computing device 106 automatically executes the instructions to launch the anti-malware control mechanism in step 204. Alternatively, the computing device 106 may be configured to execute the instructions to launch the anti-malware control mechanism in response to received input signals. The anti-malware control mechanism includes a malware scanning engine and a monitoring center. The malware scanning engine is configured to scan for malware embedded in the transferred data. The malware scanning engine may be further configured to scan the computing device 106 and the portable electronic device 102 for malware potentially stored in the data storage units of the devices. In one implementation, the malware scanning engine may be installed and executed on the computing device 106. In another implementation, the malware scanning engine may be executed on the memory space of the data security device 104. The monitoring center is configured to monitor scanning activities from the malware scanning engine. The results generated by the malware scanning engine are sent to the monitoring center. The monitoring center is configured to be executed on the computing device 106 and may be stored in the computing device 106. In one implementation, the monitoring center includes a user interface allowing for user control. The monitoring center is further configured to perform a variety of tasks, such as, without limitation, reporting scanned status to a user, updating the database of malware signatures, and allowing user to choose what action should be performed if malware is found in the transferred data or in the data storage unit.

Optionally, in step 206, the database of malware signatures for the malware scanning engine may be updated through a network connection of the computing device 106. After the anti-malware control mechanism has been launched successfully in step 204, data transmission is now allowed through a data path in step 208. The anti-malware control unit determines whether the anti-malware control mechanism is successful. In one implementation, a successful launch of the anti-malware control mechanism includes completing the installation of the malware scanning engine and the monitoring center and executing the malware scanning engine and the monitoring center in the computing device 106. In another implementation, a successful launch of the anti-malware control mechanism includes executing the malware scanning engine in the data security device 104 and completing the installation of the monitoring center on the computing device 106. After the successful launch of the anti-malware control mechanism, transmission of data is now allowed to pass through a data path in the data security device 104. In one implementation, the data path is pre-determined. In step 210, data transmitted through the data path is scanned by the malware scanning engine for malware embedded in the data. In step 212, the scanned result is reported and certain actions may be performed if malware is discovered.

When data transmission is complete and the scanning of the transmitted data ends or when the portable electronic device 102 is decoupled from the data security device 104, monitoring of the transmitted data may also end. When the disconnection happens, any data temporarily stored on the computing device 106 may be self-deleted within a pre-determined time period.

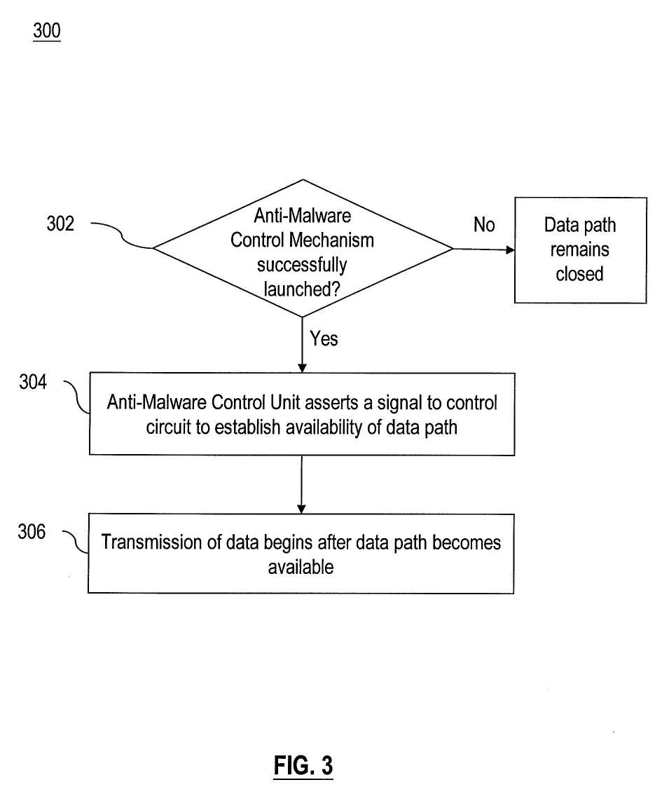

FIG. 3 is a flow chart illustrating a process 300 for allowing data transmission through a data path in a data security device 104, according to one embodiment of the present invention. As described in FIG. 2, data may be transmitted only after the anti-malware control mechanism has been launched. In one implementation, to prevent data transmission before launching the anti-malware control mechanism, availability of the data path is controlled by the anti-malware control unit through a control circuit. The anti-malware control unit may control the data path by asserting a signal to the control circuit to establish the availability of the data path. To transmit data through the data path, the anti-malware controlling unit first determines if the anti-malware control mechanism has been successfully launched in step 302. If so, the process continues to step 304. Otherwise, the data path remains unavailable, and data transmission remains suspended. In step 304, the anti-malware control unit asserts a signal to the control circuit after the anti-malware control mechanism is launched successfully. In response to the signal, the control circuit establishes the availability of the data path, and data transmission may begin in step 306.

In one configuration, the control circuit may be a power control circuit and the aforementioned signal may be a control power signal controlled by the power control circuit. The power control circuit is controlled by the anti-malware control unit and is configured to provide power to a power source of the data path. The power supply to the power source of the data path may be turned on or off by the anti-malware control unit and thus rendering the data path available or unavailable, respectively. In one implementation, the default power supply condition for the power source of the data path is configured to power-off.

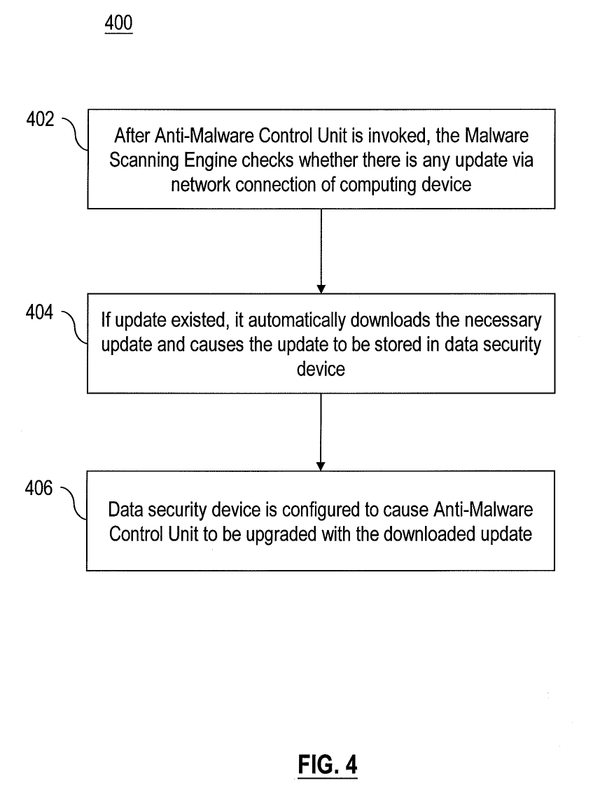

FIG. 4 is a flow chart illustrating a process 400 for updating the anti-malware control unit, according to one embodiment of the present invention. To scan for malware embedded in a data transmission, one implementation is to compare data to a database of known malware signatures. The malware scanning engine may from time to time check for the most recent version of the known malware signature. In step 402, after the anti-malware control unit is invoked, the malware scanning engine automatically checks for any new updates for known malware signatures via the network connection of the computing device 106. In step 404, if an update is available, the anti-malware control unit automatically downloads the necessary signature file. In step 406, the data security device 104 is configured to cause the malware scanning engine to be upgraded by replacing the old version of the known malware signature file with the updated version of the known malware signature file. In one implementation, the known malware signature file may be stored in a memory unit of the data security device 104. In another implementation, the known malware signature file may be temporarily stored in the computing device 106. The temporarily stored signature file may be deleted after the removal of the data security device 104 or after the computing device 106 is powered off.

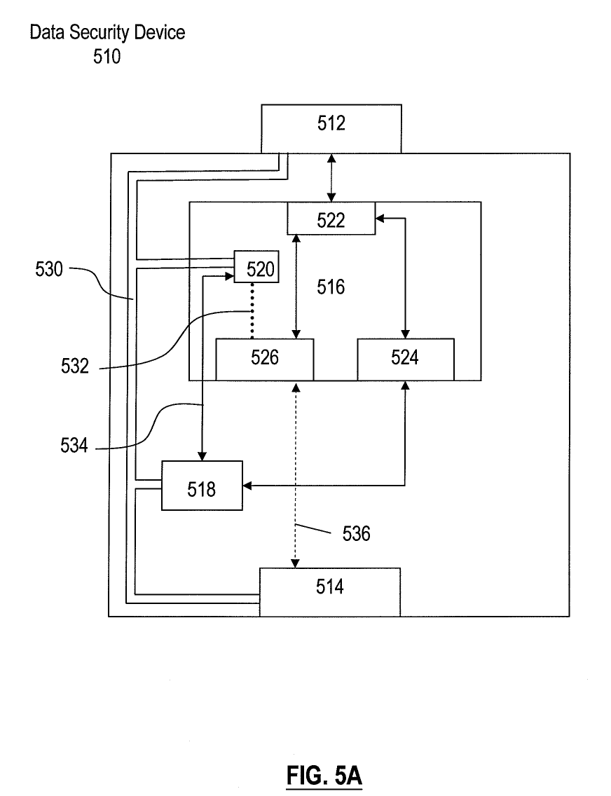

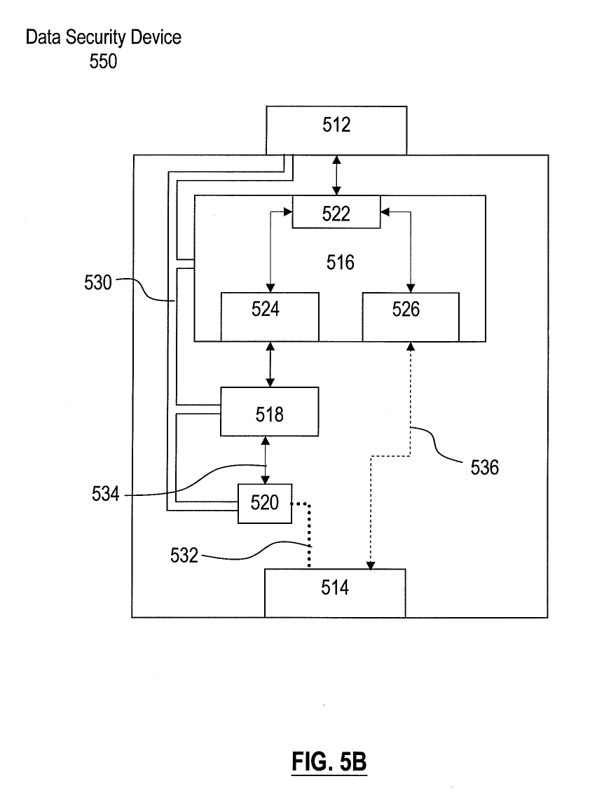

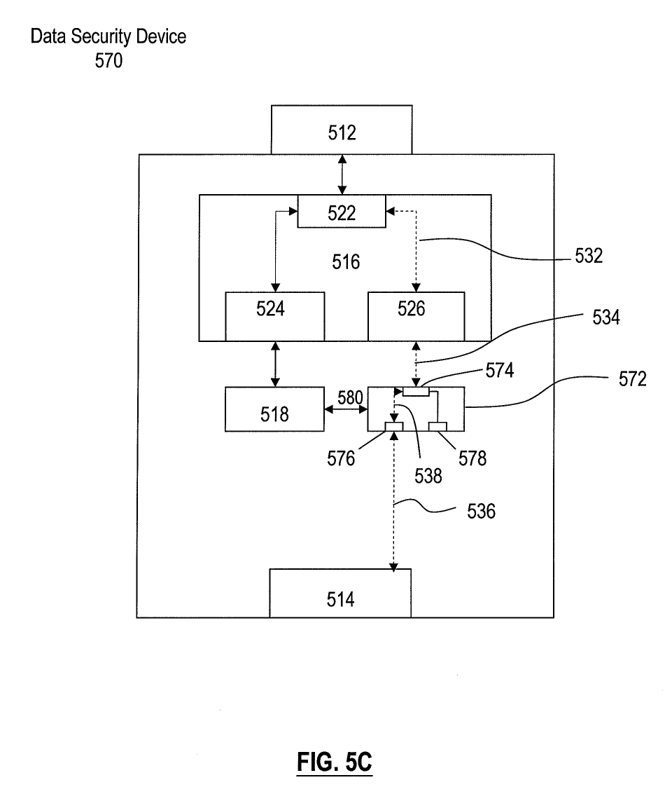

FIG. 5A illustrates a simplified block diagram of a data security device 510 configured to establish the availability of a data path with a power control circuit, according to one embodiment of the present invention. The data security device 510 includes connectors 512 and 514, a communication hub 516, and an anti-malware control unit 518. In one implementation, the connectors 512 and 514 are USB standard compliant connectors. The connector 512 is a male connector, and the connector 514 is a female connector. Both the computing device 106 and the portable electronic device 102 of FIG. 1 connect to the data security device 510 through the connectors 512 and 514, respectively. The communication hub 516, also a USB standard compliant hub in one implementation, is coupled to the connectors 512 and 514. The communication hub 516 includes an up-link port 522 and downlink ports 524 and 526 for receiving and sending command signal to and from the data security device 510. The up-link port 522 and the downlink ports 524 and 526 are configured to handle different command signals between two or more devices. Command signals passing through the up-link port 522 and the downlink ports 524 and 526 are controlled by the anti-malware control unit. Some examples of the command signals include, without limitation, a control power signal and a control path signal. In one implementation, the downlink port 524 is mainly for the anti-malware control unit 518 to communicate with the computing device 106 through the connector 512. On the other hand, the downlink port 526 is mainly for the computing device 106 to communicate with the portable electronic device 102 through the connector 514. A data path 536 may be present between the downlink port 526 and the connector 514 for the transmission of the data signal.

The anti-malware control unit 518 is configured to launch the anti-malware control mechanism after having received power. A power path 530 generally refers to a path utilized to distribute power throughout the data security device 510. Through the power path 530, power is supplied to the communication hub 516, the anti-malware control unit 518, and the connector 514. The anti-malware control unit 518 further controls the distribution of power to the downlink port 526. To control power supply to the downlink port 526, a power control circuit 520 is embedded in the communication hub 516 and is controlled by the anti-malware control unit 518 as indicated by a signal line 534. The power control circuit 520 is further coupled to a controlled power path 532, which supplies power to the downlink port 526. The controlled power path 532 is turned on by the anti-malware control unit 518 if a successful launch of the anti-malware control mechanism is detected. Specifically, the anti-malware control unit 518 can turn on power supply to the downlink port 526 by sending a control power signal through the signal line 534. If the downlink port 526 does not receive the control power signal, the downlink port 526 remains turned off. When the downlink port 526 is turned off, the data path 536 remains unavailable. When power is not supplied to a power source of the data path 536, no signal is allowed to pass and the transmission of data from one device to another is effectively suspended.

FIG. 5B illustrates a simplified block diagram of a data security device 550 configured to establish the availability of a data path with a power control circuit, according to another embodiment of the present invention. To suspend the transmission of data between devices, power supply to the connector 514 may also be controlled. Without power supply, the connector 514 is unable to function properly and transmission of data may be effectively suspended. In this embodiment, to control the power supply to the connector 514, the power control circuit 520 and the controlled power path 532 are positioned independently from the communication hub 516. The anti-malware control unit 518 controls the communication hub 516 and the power control circuit 520 separately and independently. The power path 530 extends from the anti-malware control unit 518 to the power control circuit 520. In one implementation, the anti-malware control unit 518 is able to control the power supply to the controlled power path 532 by sending a control power signal through signal line 534 to the power control circuit 520, if anti-malware control mechanism is launched successfully.

FIG. 5C illustrates a simplified block diagram of a data security device 570 configured to establish the availability of a data path with a connecting switch, according to one embodiment of the present invention. In this embodiment, instead of controlling the power supply to the downlink port 526 or the connector 514, a connecting switch 572 is utilized to establish the data path 536. The data security device 570 includes a similar configuration as the one described in FIG. 5B. However, instead of using a power control circuit and a controlled power path to manage the data transmission, the connecting switch 572 with an up-link port 574 and downlink ports 576 and 578 is used. In the connecting switch 572, both the downlink ports 576 and 578 are coupled to the up-link port 574. In one implementation, the downlink port 576 is coupled to the connector 514 and is a part of the data paths 532, 534, 536, and 538. On the other hand, there is an open circuit between the downlink port 578, which is also coupled to the up-link port 574, and the connector 514. A data path to the connector 514 can be established by selecting the downlink port 576. To render the data path to the connector 514 unavailable, the downlink port 578 is selected. In this manner, data transmission can be effectively controlled without affecting power supply to the data security device 570. How the data path 534 is connected to a selected downlink port in the connecting switch 572 may depend on the changing states associated with the data paths. In one implementation, before data transmission is allowed through the illustrated data paths 532, 534, 536, and 538, an initial state associated with the data path to the connector 514 may be defined as open. If the anti-malware control unit 518 determines that the anti-malware control mechanism is successfully launched, then the initial state is changed from open to short. In one configuration, to establish a data path by connecting the data path 534, the data path 536, and the data path 538 via the selected downlink port 576, different command signals, for example, may be asserted from the anti-malware control unit 518 to the connecting switch 572 through a signal line 580. As discussed in previous paragraphs, the availability of the data paths 532, 534, 536, and 538 depend on the successful launch of the anti-malware control mechanism.

In one implementation, before determining if the launch of the anti-malware control mechanism is successful, a first control path signal is asserted to the connecting switch 572 by the anti-malware control unit 518 to inform the connecting switch 572 to select the downlink port 578, which is not coupled to the connector 514. When the anti-malware control unit 518 determines that the anti-malware control mechanism is successfully launched, a second control path signal is then asserted to the connecting switch 572 to select the downlink port 576 and causes the availability of the data path 536 to be established. In another configuration, before the successful launch of the anti-malware control mechanism is determined, the anti-malware control unit 518 configures the connecting switch 572 to an initial condition of off, and thus the data paths 532, 534, 536, and 538 are unavailable. The initial condition may be changed after a successful launch of the anti-malware control mechanism is detected. The anti-malware control unit 518 may assert a control path signal to the connecting switch 572 and changes the initial condition to on, so that the data paths 532, 534, 536, and 538 become available. Data transfer can then begin.

The above description illustrates various embodiments of the present invention along with examples of how aspects of the present invention may be implemented. The above examples, embodiments, instruction semantics, and drawings should not be deemed to be the only embodiments, and are presented to illustrate the flexibility and advantages of the present invention as defined by the following claims.

We claim:

1. A method for preventing spreading of malware, comprising:
automatically launching an anti-malware control mechanism after a data security device connects to a computing device and receives power from the computing device;
determining availability of a data path in the data security device before allowing data to pass through the data path; and
scanning the data that passes through the data path.

2. The method of claim 1, further comprising updating a database of known malware signatures through a network connection of the computing device.

3. The method of claim 1, wherein the determining step further comprises controlling the availability of the data path based on a result of the launching step.

4. The method of claim 3, wherein the availability of the data path is based on whether power is supplied to a power source of the data path.

5. The method of claim 3, wherein the availability of the data path is based on whether the data path is selected to transfer the data.

6. The method of claim 3, wherein the availability of the data path is based on whether the data path is switched on to transfer the data.

7. The method of claim 1, wherein the anti-malware mechanism includes an anti-malware control unit configured to control the availability of the data path.

8. A device for preventing spreading of malware, comprising:
a connector for the connection with another device;
a communication hub with an up-link port and a downlink port for the transmission of signals;
a control circuit for establishing the availability of a data path; and
an anti-malware control unit configured to determine the availability of the data path by launching an anti-malware control mechanism.

9. The device of claim 8, wherein the anti-malware control mechanism comprises a malware scanning engine and a monitoring center.

10. The device of claim 8, wherein the control circuit receives command signals sent by the anti-malware control unit.

11. The device of claim 10, wherein the command signal may be a control power signal or a control path signal.

12. The device of claim 8, wherein the control circuit may be a power control circuit or a connecting switch.

13. The device of claim 12, wherein the power control circuit is coupled to a controlled power path and controls power supply to a power source of the data path.

14. The device of claim 12, the power control circuit may be an independent circuit or embedded in an integrated circuit module.

15. The device of claim 11, wherein the control power signal allows power supply to the controlled power path after a successful launch of the anti-malware control mechanism is detected by the anti-malware control unit.

16. The device of claim 11, wherein the control path signal allows the data path to be coupled through a communication port in the connecting switch after a successful launch of the anti-malware control mechanism is detected by the anti-malware control unit.

17. A computer-readable medium containing a sequence of instructions executable within a computing device including a processing unit and a physical memory, wherein the sequence of instructions, when executed by the processing unit, causes the processing unit to:
automatically launch an anti-malware control mechanism after a data security device connects to a computing device and receives power from the computing device;
determine availability of a data path in the data security device before allowing data to pass through the data path; and
scan the data that passes through the data path.

18. The computer-readable medium of claim 17, further containing a sequence of instructions, which when executed by the processing unit in the computing device, causes the processing unit to:
determine the availability of the data path based on whether power is supplied to a power source of the data path.

19. The computer-readable medium of claim 17, further containing a sequence of instructions, which when executed by the processing unit in the computing device, causes the processing unit to:
determine the availability of the data path based on whether the data path is selected to transfer the data.

20. The computer-readable medium of claim 17, further containing a sequence of instructions, which when executed by the processing unit in the computing device, causes the processing unit to:
determine the availability of the data path based on whether the data path is switched on to transfer the data.
